(19) United States
(12) Patent Application Publication
(10) Pub. No.: US 2024/0297452 A1
(43) Pub. Date: Sep. 5, 2024

(54) CONNECTOR

(71) Applicant: Japan Aviation Electronics Industry, Limited, Tokyo (JP)

(72) Inventor: Kenta ASHIBU, Tokyo (JP)

(21) Appl. No.: 18/431,372

(22) Filed: Feb. 2, 2024

(30) Foreign Application Priority Data
Mar. 2, 2023 (JP) 2023-031701

(51) Int. Cl. H01R 13/04; H01R 13/11

(52) U.S. Cl. CPC H01R 13/04; H01R 13/113

(57) ABSTRACT

A connector includes a spring member attached to a first terminal and configured to press a second terminal toward the first terminal, the first terminal including a first opposing surface and a first contact portion facing the second terminal, the second terminal including a second opposing surface opposing the first opposing surface and a second contact portion facing the first terminal, one of the first opposing surface and the second opposing surface being provided with a projection projecting toward another of the first opposing surface and the second opposing surface, the another being provided with a projection accommodation portion of recess shape for accommodating the projection, the second terminal being inserted between the first opposing surface and the spring member.

### BACKGROUND OF THE INVENTION

The present invention relates to a connector, particularly to a connector in which a second terminal of flat plate shape is moved in parallel with and superposed on a first terminal of flat plate shape, thereby connecting the first terminal and the second terminal to each other.

Conventionally, there has been known a connector for connecting a first terminal and a second terminal to each other with an operation of insertion and withdrawal of the second terminal into and from the first terminal.

For example, JP 2015-222621 A discloses a connector as illustrated in FIG. 51. In this connector, a second terminal 3 is inserted between a pair of elastic contact pieces 2 of a first terminal 1, whereby the pair of elastic contact pieces 2 each make contact with the second terminal 3 with a predetermined elastic force, and hence the first terminal 1 and the second terminal 3 are electrically connected to each other.

Meanwhile, in the course of inserting the second terminal 3 between the pair of elastic contact pieces 2 of the first terminal 1, the second terminal 3 is slid while constantly receiving a predetermined elastic force from the pair of elastic contact pieces 2; therefore, slid portions of the elastic contact pieces 2 and the second terminal 3 are easily worn.

In addition, in the connecting state between the first terminal 1 and the second terminal 3, also when the first terminal 1 and the second terminal 3 are moved relatively to each other by, for example, receiving any external force, slid portions between the elastic contact pieces 2 and the second terminal 3 are easily worn.

Hence, reliability of electrical connection between the first terminal 1 and the second terminal 3 may be impaired.

### SUMMARY OF THE INVENTION

The present invention has been made to overcome the conventional problems as above and aims at providing a connector that can electrically connect a first terminal to a second terminal with high reliability even with an operation of insertion and withdrawal of the second terminal into and from the first terminal.

The connector according to the invention is a connector in which a second terminal of flat plate shape is moved in parallel with and superposed on a first terminal of flat plate shape to thereby connect the first terminal and the second terminal to each other, the connector including:
a spring member attached to the first terminal and configured to press the second terminal toward the first terminal;
wherein the first terminal includes a first opposing surface and a first contact portion facing the second terminal,
a second terminal accommodation portion in which the second terminal is inserted is formed between the first opposing surface and the spring member,
the second terminal includes a second opposing surface opposing the first opposing surface, a second contact portion facing the first terminal, and a pressed portion formed on and projecting from a spring member-opposing surface opposing the spring member,
one of the first opposing surface and the second opposing surface is provided with a projection projecting toward another of the first opposing surface and the second opposing surface, and the another is provided with a projection accommodation portion of recess shape for accommodating the projection, and
when the second terminal is inserted along a predetermined insertion direction to a predetermined connection completion position in the second terminal accommodation portion, the projection is accommodated in the projection accommodation portion so that the second terminal is retained at the predetermined connection completion position, the second terminal is pressed against the first terminal by the spring member via the pressed portion, and the first contact portion and the second contact portion make contact with each other, whereby the first terminal and the second terminal are electrically connected to each other.

### BRIEF DESCRIPTION OF THE DRAWINGS

FIG. 1 is a perspective view showing a connector according to Embodiment 1 before connection.

FIG. 2 is a perspective view showing a first terminal structure in Embodiment 1.

FIG. 3 is a side view showing the first terminal structure in Embodiment 1.

FIG. 4 is a perspective view of the first terminal in Embodiment 1 when viewed from a front surface side.

FIG. 5 is a perspective view of the first terminal in Embodiment 1 when viewed from a back surface side.

FIG. 6 is a perspective view of a second terminal in Embodiment 1 when viewed from a front surface side.

FIG. 7 is a perspective view of the second terminal in Embodiment 1 when viewed from a back surface side.

FIG. 8 is a plan view showing the connector of Embodiment 1 at an early stage of insertion of the second terminal.

FIG. 9 is a cross-sectional view corresponding to line A-A of FIG. 8 and showing the connector of Embodiment 1 at an early stage of insertion of the second terminal.

FIG. 10 is a cross-sectional view corresponding to line A-A of FIG. 8 and showing the connector of Embodiment 1 in the process of insertion of the second terminal.

FIG. 11 is a cross-sectional view corresponding to line A-A of FIG. 8 and showing the connector of Embodiment 1 with the second terminal being inserted to a connection completion position.

FIG. 12 is a perspective view showing a connector according to Embodiment 2 before connection.

FIG. 13 is a side view showing a first terminal structure in Embodiment 2.

FIG. 14 is a perspective view of the first terminal in Embodiment 2 when viewed from a front surface side.

FIG. 15 is a perspective view of the first terminal in Embodiment 2 when viewed from a back surface side.

FIG. 16 is a perspective view of a second terminal in Embodiment 2 when viewed from a front surface side.

FIG. 17 is a perspective view of the second terminal in Embodiment 2 when viewed from a back surface side.

FIG. 18 is a plan view showing the connector of Embodiment 2 at an early stage of insertion of the second terminal.

FIG. 19 is a cross-sectional view corresponding to line B-B of FIG. 18 and showing the connector of Embodiment 2 at an early stage of insertion of the second terminal.

FIG. 20 is a cross-sectional view corresponding to line B-B of FIG. 18 and showing the connector of Embodiment 2 in the process of insertion of the second terminal.

FIG. 21 is a cross-sectional view corresponding to line B-B of FIG. 18 and showing the connector of Embodiment 2 with the second terminal being inserted to a connection completion position.

FIG. 22 is a perspective view showing a connector according to Embodiment 3 before connection.

FIG. 23 is a side view showing a first terminal structure in Embodiment 3.

FIG. 24 is a perspective view of the first terminal in Embodiment 3 when viewed from a front surface side.

FIG. 25 is a perspective view of the first terminal in Embodiment 3 when viewed from a back surface side.

FIG. 26 is a perspective view of a second terminal in Embodiment 3 when viewed from a front surface side.

FIG. 27 is a perspective view of the second terminal in Embodiment 3 when viewed from a back surface side.

FIG. 28 is a plan view showing the connector of Embodiment 3 at an early stage of insertion of the second terminal.

FIG. 29 is a cross-sectional view corresponding to line C-C of FIG. 28 and showing the connector of Embodiment 3 at an early stage of insertion of the second terminal.

FIG. 30 is a cross-sectional view corresponding to line D-D of FIG. 28 and showing the connector of Embodiment 3 at the early stage of insertion of the second terminal.

FIG. 31 is a cross-sectional view corresponding to line C-C of FIG. 28 and showing the connector of Embodiment 3 in the process of insertion of the second terminal.

FIG. 32 is a cross-sectional view corresponding to line D-D of FIG. 28 and showing the connector of Embodiment 3 in the process of insertion of the second terminal.

FIG. 33 is a cross-sectional view corresponding to line C-C of FIG. 28 and showing the connector of Embodiment 3 with the second terminal being inserted to a connection completion position.

FIG. 34 is a cross-sectional view corresponding to line D-D of FIG. 28 and showing the connector of Embodiment 3 with the second terminal being inserted to a connection completion position.

FIG. 35 is a perspective view showing a connector according to Embodiment 4 before connection.

FIG. 36 is a side view showing a first terminal structure in Embodiment 4.

FIG. 37 is a perspective view showing the first terminal to which a projection forming component is attached in Embodiment 4.

FIG. 38 is a perspective view of the first terminal in Embodiment 4 when viewed from a front surface side.

FIG. 39 is a perspective view of the first terminal in Embodiment 4 when viewed from a back surface side.

FIG. 40 is a perspective view of the projection forming component in Embodiment 4 when viewed from a front surface side.

FIG. 41 is a perspective view of the projection forming component in Embodiment 4 when viewed from a back surface side.

FIG. 42 is a perspective view of a second terminal in Embodiment 4 when viewed from a front surface side.

FIG. 43 is a perspective view of the second terminal in Embodiment 4 when viewed from a back surface side.

FIG. 44 is a plan view showing the connector of Embodiment 4 at an early stage of insertion of the second terminal.

FIG. 45 is a cross-sectional view corresponding to line E-E of FIG. 44 and showing the connector of Embodiment 4 at an early stage of insertion of the second terminal.

FIG. 46 is a cross-sectional view corresponding to line F-F of FIG. 44 and showing the connector of Embodiment 4 at an early stage of insertion of the second terminal.

FIG. 47 is a cross-sectional view corresponding to line E-E of FIG. 44 and showing the connector of Embodiment 4 in the process of insertion of the second terminal.

FIG. 48 is a cross-sectional view corresponding to line F-F of FIG. 44 and showing the connector of Embodiment 4 in the process of insertion of the second terminal.

FIG. 49 is a cross-sectional view corresponding to line E-E of FIG. 44 and showing the connector of Embodiment 4 with the second terminal being inserted to a connection completion position.

FIG. 50 is a cross-sectional view corresponding to line F-F of FIG. 44 and showing the connector of Embodiment 4 with the second terminal being inserted to a connection completion position.

FIG. 51 is a side view showing a conventional connector.

### DETAILED DESCRIPTION OF THE INVENTION

Embodiments of the present invention are described below based on the accompanying drawings.

### Embodiment 1

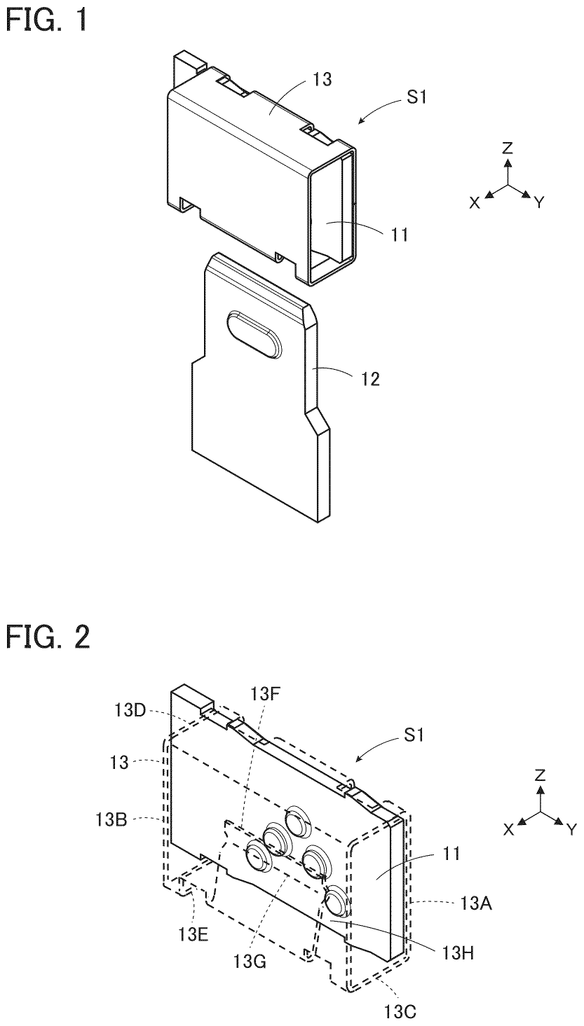

FIG. 1 shows a connector according to Embodiment 1. The connector includes a first terminal 11 and a second terminal 12. To the first terminal 11, a spring member retaining portion 13 is attached, and the first terminal 11 and the spring member retaining portion 13 constitute a first terminal structure S1.

The first terminal 11 and the second terminal 12 are each made of a conductive material such as metal and have a flat plate shape.

The second terminal 12 is inserted in the first terminal structure S1 to be thereby electrically connected to the first terminal 11.

For convenience, the first terminal 11 and the second terminal 12 both of flat plate shape are defined as extending along a YZ plane, while the direction in which the second terminal 12 is inserted into the first terminal structure S1 is defined as a +Z direction, and the direction perpendicular to the first terminal 11 and the second terminal 12 as a X direction.

FIG. 2 shows the first terminal structure S1. In FIG. 2, the spring member retaining portion 13 is illustrated by dashed lines to show an interior of the spring member retaining portion 13.

The spring member retaining portion 13 is constituted of a plate member such as a metal plate being bent, and has a substantially polygonal tube shape whose central axis extends along the Y direction. Specifically, the spring member retaining portion 13 includes a bottom plate portion 13A situated on the −X direction side and extending along a YZ plane, a top plate portion 13B situated on the +X direction side and extending along a YZ plane, a front plate portion 13C situated on the −Z direction side and extending along an XY plane, and a rear plate portion 13D situated on the +Z direction side and extending along an XY plane.

The front plate portion 13C is provided with an opening 13E into which the second terminal 12 is to be inserted. A spring member 13F extending while being bent in the −X direction and the +Z direction is formed at the −Z directional end of the top plate portion 13B. At a tip portion of the spring member 13F, a pressing portion 13G is formed to extend in the Y direction and protrude toward the −X direction.

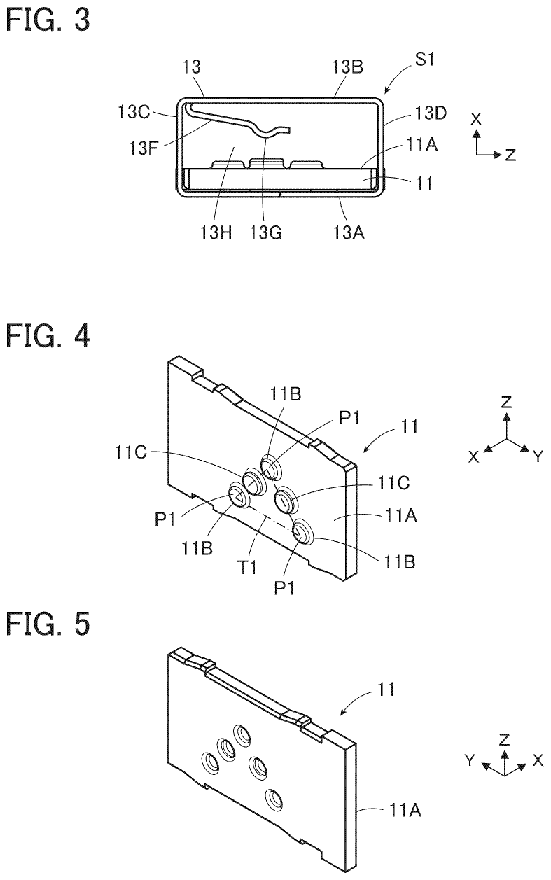

As shown in FIG. 3, the height of the top plate portion 13B in the X direction from the bottom plate portion 13A has a larger dimension than the thickness of the first terminal 11 in the X direction, and the spring member retaining portion 13 is attached to the first terminal 11 in such a manner that the first terminal 11 is situated inside the spring member retaining portion 13 and in contact with the bottom plate portion 13A of the spring member retaining portion 13.

The +X directional surface of the first terminal 11 constitutes a first opposing surface 11A opposing the second terminal 12, and between the first opposing surface 11A of the first terminal 11 and the spring member 13F, formed is a second terminal accommodation portion 13H in which the second terminal 12 is inserted.

As shown in FIG. 4, the first opposing surface 11A of the first terminal 11 is provided with three first protrusion portions 11B each projecting toward the +X direction. The three first protrusion portions 11B are arranged at three vertexes of an isosceles triangle T1 having a symmetrical shape with respect to the Z direction, and a first contact portion P1 is formed at a top part, facing in the +X direction, of each first protrusion portion 11B.

The first opposing surface 11A of the first terminal 11 is also provided with two projections 11C each projecting in the +X direction. The two projections 11C are separately arranged on two sides of the isosceles triangle T1, the two sides having the same length. Specifically, each projection 11C is situated at a center part of the relevant side of the isosceles triangle T1 and is so situated as not to overlap the three first contact portions P1 in the Z direction, i.e., insertion direction of the second terminal 12.

The projection height of the two projections 11C from the first opposing surface 11A is higher than the projection height of the three first protrusion portions 11B from the first opposing surface 11A, and a top part in the +X direction of each projection 11C is situated on the +X direction side from the first contact portion P1.

The three first protrusion portions 11B and the two projections 11C can be formed by subjecting the first terminal 11 to press working, and the back surface on the −X direction side of the first terminal 11 is thus provided with five recesses corresponding to the first protrusion portions 11B and the projections 11C as shown in FIG. 5. That is, the two projections 11C are integrally formed with the first opposing surface 11A.

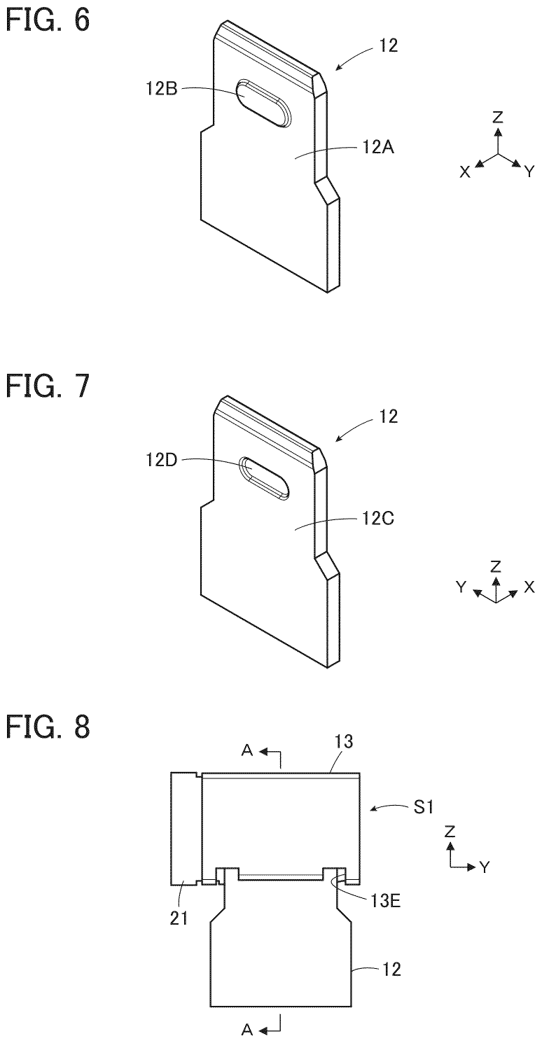

As shown in FIG. 6, the front surface on the +X direction side of the second terminal 12 constitutes a spring member-opposing surface 12A opposing the spring member 13F when the second terminal 12 is inserted in the second terminal accommodation portion 13H of the first terminal structure S1, and the spring member-opposing surface 12A is provided with a pressed portion 12B projecting toward the +X direction. The pressed portion 12B has a shape elongated along the Y direction.

In addition, as shown in FIG. 7, the back surface on the −X direction side of the second terminal 12 constitutes a second opposing surface 12C opposing the first opposing surface 11A of the first terminal 11 when the second terminal 12 is inserted in the second terminal accommodation portion 13H of the first terminal structure S1, and the second opposing surface 12C is provided with a projection accommodation portion 12D of recess shape recessed toward the +X direction.

The projection accommodation portion 12D is elongated along the Y direction and has a size with which the two projections 11C of the first terminal 11 can be together accommodated therein. Further, the projection accommodation portion 12D has a depth dimension larger than the height difference in the X direction between the top parts of the projections 11C and the first contact portion P1 of the first terminal 11.

The pressed portion 12B and the projection accommodation portion 12D can be simultaneously formed by a single step of subjecting the second terminal 12 to press working, and are arranged at the same position in a YZ plane.

Next, the operation of the connector according to Embodiment 1 is described.

To electrically connect the second terminal 12 to the first terminal 11, the second terminal 12 shown in FIG. 1 is moved in the +Z direction from the −Z direction, and the tip end of the second terminal 12 is inserted into the spring member retaining portion 13 through the opening 13E of the spring member retaining portion 13 of the first terminal structure S1 as shown in FIG. 8.

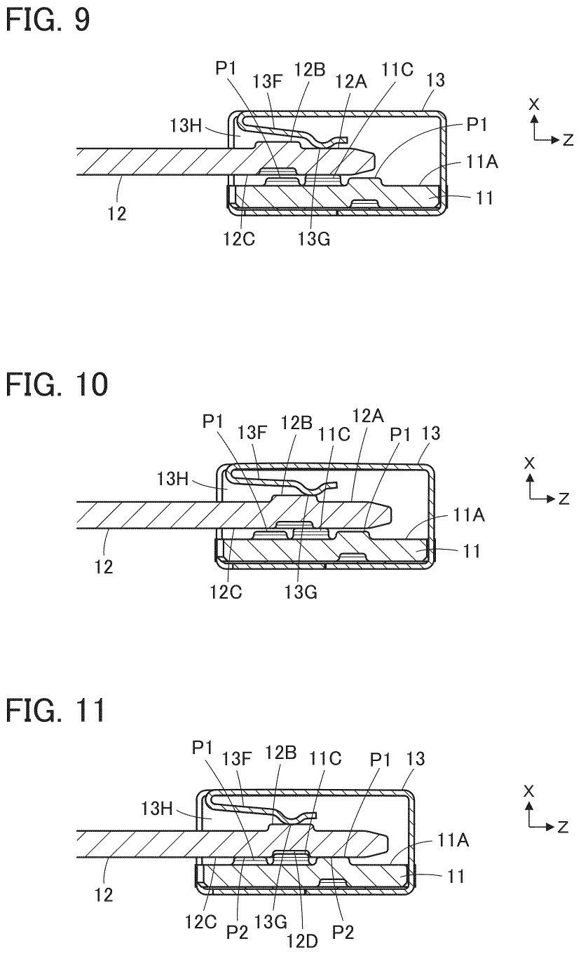

In this process, as shown in FIG. 9, the +Z directional tip end of the second terminal 12 is inserted in the +Z direction as passing between the first terminal 11 and the spring member 13F, and the top parts of the two projections 11C of the first terminal 11 are situated on the +X direction side from the first contact portions P1. Hence, the second opposing surface 12C, facing in the −X direction, of the second terminal 12 is situated over the top parts of the two projections 11C without making contact with the first contact portions P1, and the spring member-opposing surface 12A, facing in the +X direction, of the second terminal 12 makes contact with the pressing portion 13G of the spring member 13F to elastically compress the spring member 13F toward the +X direction.

In this state, the second terminal 12 is inserted in the second terminal accommodation portion 13H formed between the spring member 13F and the first opposing surface 11A of the first terminal 11.

In the state as shown in FIG. 9, the pressed portion 12B projecting in the +X direction from the spring member-opposing surface 12A of the second terminal 12 is situated on the −Z direction side from the pressing portion 13G of the spring member 13F and is thus not in contact with the pressing portion 13G yet.

When the second terminal 12 is inserted further in the +Z direction, as shown in FIG. 10, with the second opposing surface 12C of the second terminal 12 being kept over the top parts of the two projections 11C of the first terminal 11, the pressed portion 12B of the second terminal 12 makes contact with the pressing portion 13G of the spring member 13F, and the pressing portion 13G rides on the pressed portion 12B projecting in the +X direction from the spring member-opposing surface 12A of the second terminal 12.

In this state, when insertion of the second terminal 12 in the +Z direction continues, as shown in FIG. 11, with the pressing portion 13G of the spring member 13F being kept on the pressed portion 12B of the second terminal 12, the projection accommodation portion 12D formed in the second opposing surface 12C of the second terminal 12 is situated on the +X direction side from the two projections 11C of the first terminal 11 and accommodates the two projections 11C. The position of the second terminal 12 in the second terminal accommodation portion 13H at this time is called “connection completion position.”

Since the projection accommodation portion 12D of the second terminal 12 has a depth dimension larger than the height difference in the X direction between the top parts of the projections 11C and the first contact portions P1 of the first terminal 11, when the second terminal 12 is disposed at the connection completion position and the two projections 11C are thus accommodated in the projection accommodation portion 12D, a predetermined gap is formed between the top part of each projection 11C and the bottom part of the projection accommodation portion 12D, and the second opposing surface 12C of the second terminal 12 makes contact with the three first contact portions P1 of the first terminal 11.

At this time, three places in the second opposing surface 12C at which the three first contact portions P1 are in contact therewith each form a second contact portion P2 in the second terminal 12.

Since the pressing portion 13G of the spring member 13F is positioned on the pressed portion 12B of the second terminal 12 as shown in FIG. 11, the second terminal 12 is pressed against the first terminal 11 by the spring member 13F via the pressed portion 12B, and the first contact portions P1 and the second contact portions P2 make contact with each other with a predetermined contact pressure, whereby the first terminal 11 and the second terminal 12 are electrically connected to each other.

As described above, during the process of inserting the second terminal 12 to the connection completion position, the second opposing surface 12C of the second terminal 12 is in contact only with the top parts of the two projections 11C of the first terminal 11, and when the second terminal 12 is disposed at the connection completion position and the two projections 11C are accommodated in the projection accommodation portion 12D, the second opposing surface 12C of the second terminal 12 makes contact with the three first contact portions P1 of the first terminal 11 for the first time.

Moreover, since the two projections 11C of the first terminal 11 are so situated as not to overlap the three first contact portions P1 in the Z direction, i.e., insertion direction of the second terminal 12, the three first contact portions P1 of the first terminal 11 make contact with the three second contact portions P2 of the second terminal 12 without being rubbed by any part of the second terminal 12. Similarly, the three second contact portions P2 of the second terminal 12 make contact with the three first contact portions P1 of the first terminal 11 without being rubbed by any part of the first terminal 11.

Hence, it is possible to largely suppress wear of the first contact portions P1 and the second contact portions P2 in the process of insertion of the second terminal 12 into the second terminal accommodation portion 13H to thereby electrically connect the first terminal 11 and the second terminal 12 to each other with high reliability.

### Embodiment 2

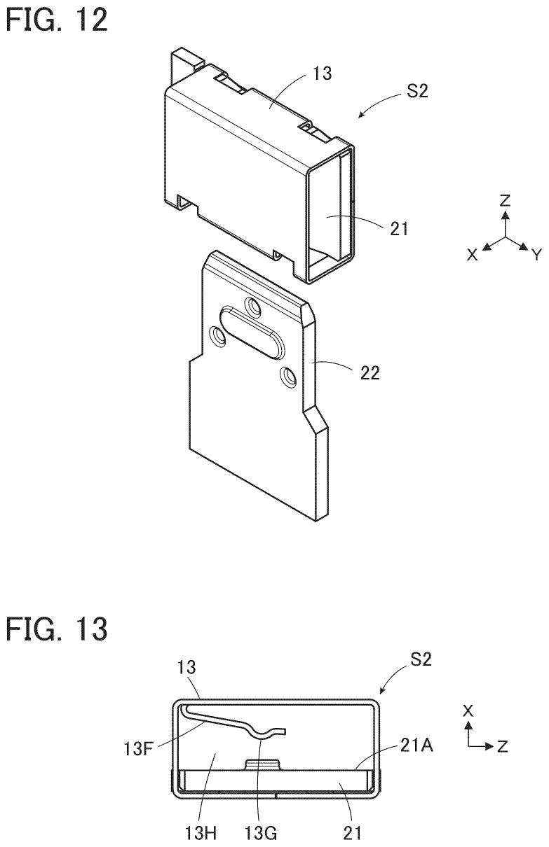

FIG. 12 shows a connector according to Embodiment 2. The connector includes a first terminal 21 and a second terminal 22. To the first terminal 21, the spring member retaining portion 13 is attached, and the first terminal 21 and the spring member retaining portion 13 constitute a first terminal structure S2.

The first terminal 21 and the second terminal 22 are each made of a conductive material such as metal and have a flat plate shape.

The second terminal 22 is inserted in the first terminal structure S2 to be thereby electrically connected to the first terminal 21.

The spring member retaining portion 13 is the same as the spring member retaining portion 13 used in the first terminal structure S1 in Embodiment 1.

As shown in FIG. 13, the spring member retaining portion 13 is attached to the first terminal 21 in such a manner that the first terminal 21 is situated inside the spring member retaining portion 13 and in contact with the bottom plate portion 13A of the spring member retaining portion 13.

The +X directional surface of the first terminal 21 constitutes a first opposing surface 21A opposing the second terminal 22, and between the first opposing surface 21A of the first terminal 21 and the spring member 13F, formed is the second terminal accommodation portion 13H in which the second terminal 22 is inserted.

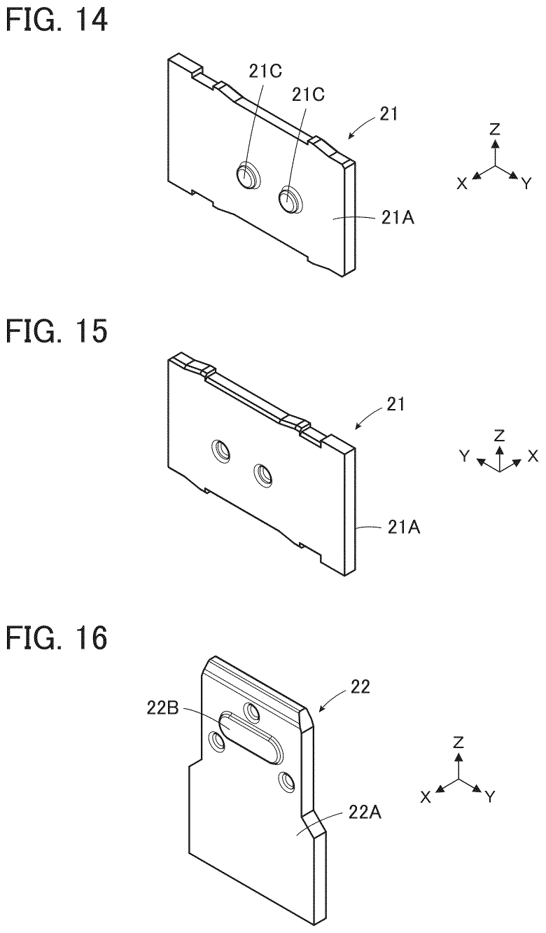

As shown in FIG. 14, the first opposing surface 21A of the first terminal 21 is provided with two projections 21C each projecting in the +X direction. The two projections 21C are aligned in the Y direction.

The two projections 21C can be formed by subjecting the first terminal 21 to press working, and the back surface on the −X direction side of the first terminal 21 is thus provided with two recesses corresponding to the two projections 21C as shown in FIG. 15. That is, the two projections 21C are formed as a result of deformation of the first opposing surface 21A through press working.

As shown in FIG. 16, the front surface on the +X direction side of the second terminal 22 constitutes a spring member-opposing surface 22A opposing the spring member 13F when the second terminal 22 is inserted in the second terminal accommodation portion 13H of the first terminal structure S2, and the spring member-opposing surface 22A is provided with a pressed portion 22B projecting toward the +X direction. The pressed portion 22B has a shape elongated along the Y direction.

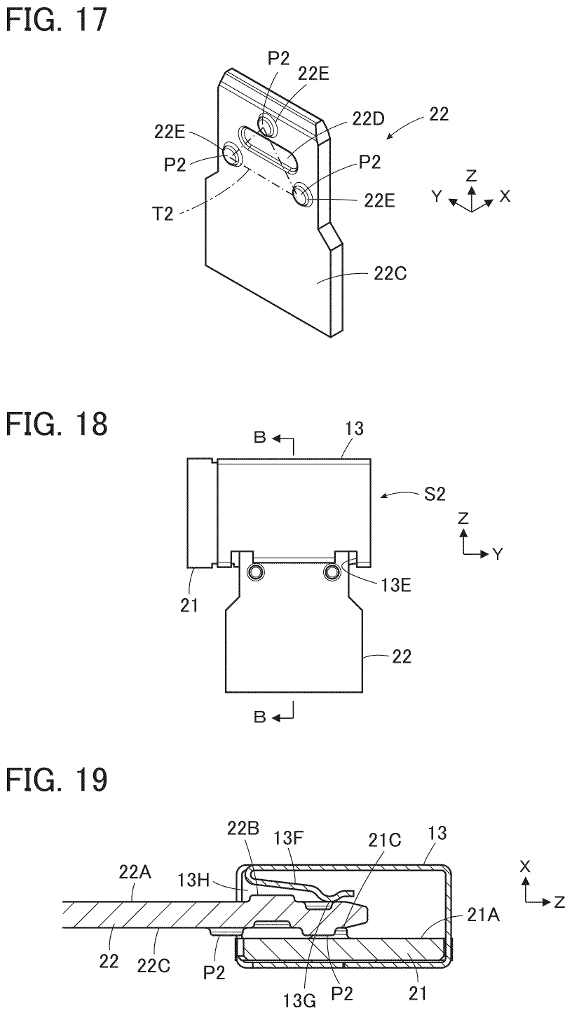

In addition, as shown in FIG. 17, the back surface on the −X direction side of the second terminal 22 constitutes a second opposing surface 22C opposing the first opposing surface 21A of the first terminal 21 when the second terminal 22 is inserted in the second terminal accommodation portion 13H of the first terminal structure S2, and the second opposing surface 22C is provided with a projection accommodation portion 22D of recess shape recessed toward the +X direction.

The projection accommodation portion 22D is elongated along the Y direction and has a size with which the two projections 21C of the first terminal 21 can be together accommodated therein.

The pressed portion 22B and the projection accommodation portion 22D can be simultaneously formed by a single step of subjecting the second terminal 22 to press working, and are arranged at the same position in a YZ plane.

In addition, the second opposing surface 22C of the second terminal 22 is provided with three second protrusion portions 22E each projecting toward the −X direction. The three second protrusion portions 22E are arranged at three vertexes of an isosceles triangle T2 having a symmetrical shape with respect to the Z direction, and a second contact portion P2 is formed at a top part, facing in the −X direction, of each second protrusion portion 22E.

When the second terminal 22 is inserted in the second terminal accommodation portion 13H of the first terminal structure S2, the two projections 21C of the first terminal 21 are accommodated in the projection accommodation portion 22D, while the three second contact portions P2 are so situated as not to overlap the two projections 21C in the Z direction, i.e., insertion direction of the second terminal 22.

The projection height of the two projections 21C of the first terminal 21 from the first opposing surface 21A is set higher than the height of the three second contact portions P2 from the second opposing surface 22C in the second terminal 22.

Further, the projection accommodation portion 22D of the second terminal 22 has a depth dimension larger than the difference between the projection height of the projections 21C of the first terminal 21 from the first opposing surface 21A and the height of the second contact portions P2 of the second terminal 22 from the second opposing surface 22C.

Next, the operation of the connector according to Embodiment 2 is described.

To electrically connect the second terminal 22 to the first terminal 21, the second terminal 22 shown in FIG. 12 is moved in the +Z direction from the −Z direction, and the tip end of the second terminal 22 is inserted into the spring member retaining portion 13 through the opening 13E of the spring member retaining portion 13 of the first terminal structure S2 as shown in FIG. 18.

At this time, as shown in FIG. 19, since the projection height of the projection 21C of the first terminal 21 from the first opposing surface 21A is higher than the height of the second contact portion P2 of the second terminal 22 from the second opposing surface 22C, the second contact portion P2 of the second terminal 22 does not make contact with the first opposing surface 21A of the first terminal 21, and the second opposing surface 22C of the second terminal 22 is situated over the top part of the projection 21C of the first terminal 21.

The spring member-opposing surface 22A, facing in the +X direction, of the second terminal 22 makes contact with the pressing portion 13G of the spring member 13F to elastically compress the spring member 13F toward the +X direction.

In this state, the second terminal 22 is inserted in the second terminal accommodation portion 13H formed between the spring member 13F and the first opposing surface 21A of the first terminal 21.

In the state as shown in FIG. 19, the pressed portion 22B of the second terminal 22 is situated on the −Z direction side from the pressing portion 13G of the spring member 13F and is thus not in contact with the pressing portion 13G yet.

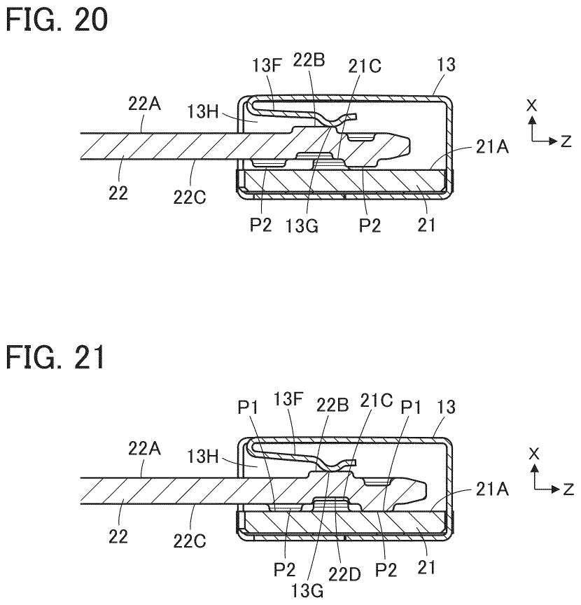

When the second terminal 22 is inserted further in the +Z direction, as shown in FIG. 20, with the second opposing surface 22C of the second terminal 22 being kept over the top parts of the two projections 21C of the first terminal 21, the pressed portion 22B of the second terminal 22 makes contact with the pressing portion 13G of the spring member 13F, and the pressing portion 13G rides on the pressed portion 22B projecting in the +X direction from the spring member-opposing surface 22A of the second terminal 22.

In this state, when insertion of the second terminal 22 in the +Z direction continues, as shown in FIG. 21, with the pressing portion 13G of the spring member 13F being kept on the pressed portion 22B of the second terminal 22, the projection accommodation portion 22D formed in the second opposing surface 22C of the second terminal 22 is situated on the +X direction side from the two projections 21C of the first terminal 21 and accommodates the two projections 21C. The position of the second terminal 22 in the second terminal accommodation portion 13H at this time is called “connection completion position.”

Since the projection accommodation portion 22D of the second terminal 22 has a depth dimension larger than the difference between the projection height of the projections 21C of the first terminal 21 from the first opposing surface 21A and the height of the second contact portions P2 of the second terminal 22 from the second opposing surface 22C, when the second terminal 22 is disposed at the connection completion position and the two projections 21C are thus accommodated in the projection accommodation portion 22D, a predetermined gap is formed between the top part of each projection 21C and the bottom part of the projection accommodation portion 22D, and the three second contact portions P2 of the second terminal 22 make contact with the first opposing surface 21A of the first terminal 21.

At this time, three places in the first opposing surface 21A at which the three second contact portions P2 are in contact therewith each form the first contact portion P1 in the first terminal 21.

Since the pressing portion 13G of the spring member 13F is positioned on the pressed portion 22B of the second terminal 22 as shown in FIG. 21, the second terminal 22 is pressed against the first terminal 21 by the spring member 13F via the pressed portion 22B, and the first contact portions P1 and the second contact portions P2 make contact with each other with a predetermined contact pressure, whereby the first terminal 21 and the second terminal 22 are electrically connected to each other.

As described above, during the process of inserting the second terminal 22 to the connection completion position, the first opposing surface 21A of the first terminal 21 is not in contact with any part of the second terminal 22, and when the second terminal 22 is disposed at the connection completion position and the two projections 21C are accommodated in the projection accommodation portion 22D, the three second contact portions P2 of the second terminal 22 make contact with the first opposing surface 21A of the first terminal 21 for the first time.

Moreover, since the two projections 21C of the first terminal 21 are so situated as not to overlap the three second contact portions P2 of the second terminal 22 in the Z direction, i.e., insertion direction of the second terminal 22, the three second contact portions P2 of the second terminal 22 make contact with the three first contact portions P1 of the first terminal 21 without being rubbed by any part of the first terminal 21. Similarly, the three first contact portions P1 of the first terminal 21 make contact with the three second contact portions P2 of the second terminal 22 without being rubbed by any part of the second terminal 22.

Hence, as with Embodiment 1, it is also possible in the connector according to Embodiment 2 to largely suppress wear of the first contact portions P1 and the second contact portions P2 in the process of insertion of the second terminal 22 into the second terminal accommodation portion 13H to thereby electrically connect the first terminal 21 and the second terminal 22 to each other with high reliability.

### Embodiment 3

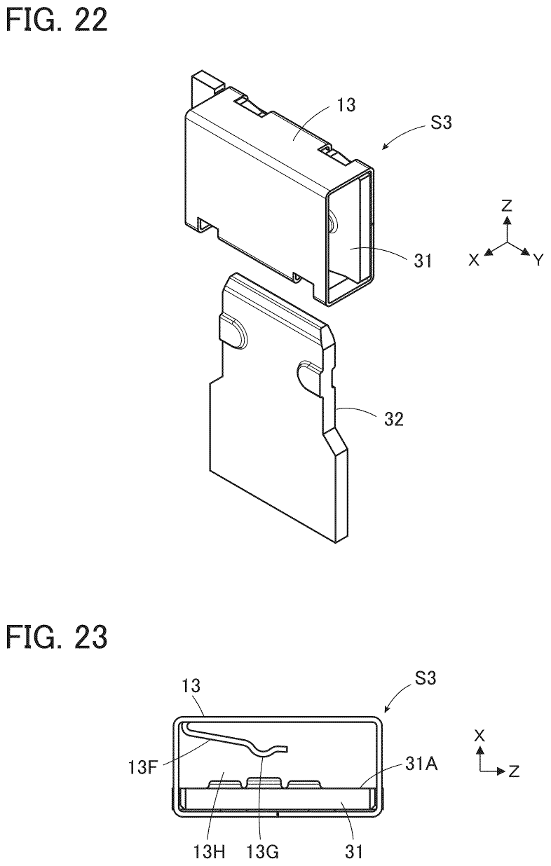

FIG. 22 shows a connector according to Embodiment 3. The connector includes a first terminal 31 and a second terminal 32. To the first terminal 31, the spring member retaining portion 13 is attached, and the first terminal 31 and the spring member retaining portion 13 constitute a first terminal structure S3.

The first terminal 31 and the second terminal 32 are each made of a conductive material such as metal and have a flat plate shape.

The second terminal 32 is inserted in the first terminal structure S3 to be thereby electrically connected to the first terminal 31.

The spring member retaining portion 13 is the same as the spring member retaining portion 13 used in the first terminal structure S1 in Embodiment 1.

As shown in FIG. 23, the spring member retaining portion 13 is attached to the first terminal 31 in such a manner that the first terminal 31 is situated inside the spring member retaining portion 13 and in contact with the bottom plate portion 13A of the spring member retaining portion 13.

The +X directional surface of the first terminal 31 constitutes a first opposing surface 31A opposing the second terminal 32, and between the first opposing surface 31A of the first terminal 31 and the spring member 13F, formed is the second terminal accommodation portion 13H in which the second terminal 32 is inserted.

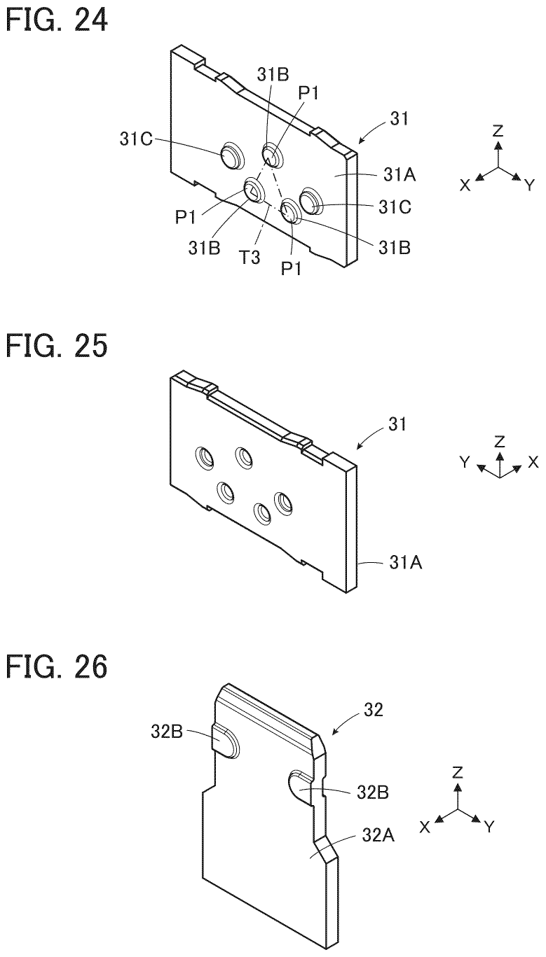

As shown in FIG. 24, the first opposing surface 31A of the first terminal 31 is provided with three first protrusion portions 31B each projecting toward the +X direction. The three first protrusion portions 31B are arranged at three vertexes of an isosceles triangle T3 having a symmetrical shape with respect to the Z direction, and a first contact portion P1 is formed at a top part, facing in the +X direction, of each first protrusion portion 31B.

The first opposing surface 31A of the first terminal 31 is also provided with two projections 31C each projecting in the +X direction. The two projections 31C are arranged outside the isosceles triangle T3. Specifically, the projections 31C are separately situated on the +Y direction side and the −Y direction side from the isosceles triangle T3 with a distance therebetween in the Y direction, and are so situated as not to overlap the three first contact portions P1 in the Z direction, i.e., insertion direction of the second terminal 32.

The projection height of the two projections 31C from the first opposing surface 31A is higher than the projection height of the three first protrusion portions 31B from the first opposing surface 31A, and a top part in the +X direction of each projection 31C is situated on the +X direction side from the first contact portion P1.

The three first protrusion portions 31B and the two projections 31C can be formed by subjecting the first terminal 31 to press working, and the back surface on the −X direction side of the first terminal 31 is thus provided with five recesses corresponding to the first protrusion portions 31B and the projections 31C as shown in FIG. 25.

As shown in FIG. 26, the front surface on the +X direction side of the second terminal 32 constitutes a spring member-opposing surface 32A opposing the spring member 13F when the second terminal 32 is inserted in the second terminal accommodation portion 13H of the first terminal structure S3, and the spring member-opposing surface 32A is provided with two pressed portions 32B projecting toward the +X direction. The two pressed portions 32B are aligned in the Y direction and disposed with a distance therebetween in the Y direction.

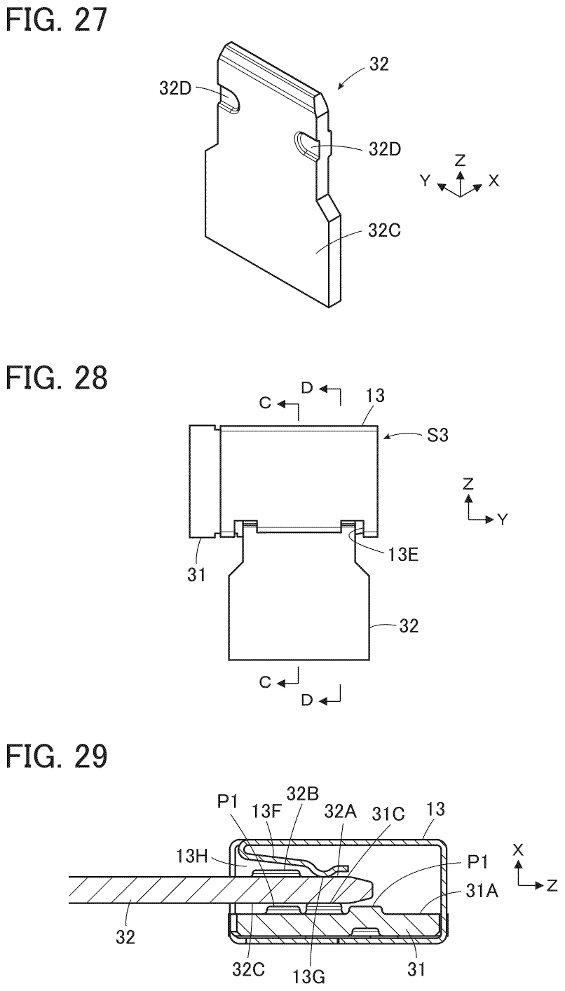

In addition, as shown in FIG. 27, the back surface on the −X direction side of the second terminal 32 constitutes a second opposing surface 32C opposing the first opposing surface 31A of the first terminal 31 when the second terminal 32 is inserted in the second terminal accommodation portion 13H of the first terminal structure S3, and the second opposing surface 32C is provided with two projection accommodation portions 32D of recess shape recessed toward the +X direction.

The two projection accommodation portions 32D are aligned in the Y direction and disposed with a distance therebetween in the Y direction. The distance in the Y direction between the two projection accommodation portions 32D is set equal to the distance in the Y direction between the two projections 31C of the first terminal 31. In addition, each projection accommodation portion 32D has a size with which the projection 31C of the first terminal 31 can be accommodated therein.

Moreover, the two projection accommodation portions 32D each have a depth dimension larger than the height difference in the X direction between the top part of the projection 31C and the first contact portion P1 of the first terminal 31.

The two pressed portions 32B and the two projection accommodation portions 32D can be simultaneously formed by a single step of subjecting the second terminal 32 to press working, and are arranged at the same positions in a YZ plane.

Next, the operation of the connector according to Embodiment 3 is described.

To electrically connect the second terminal 32 to the first terminal 31, the second terminal 32 shown in FIG. 22 is moved in the +Z direction from the −Z direction, and the tip end of the second terminal 32 is inserted into the spring member retaining portion 13 through the opening 13E of the spring member retaining portion 13 of the first terminal structure S3 as shown in FIG. 28.

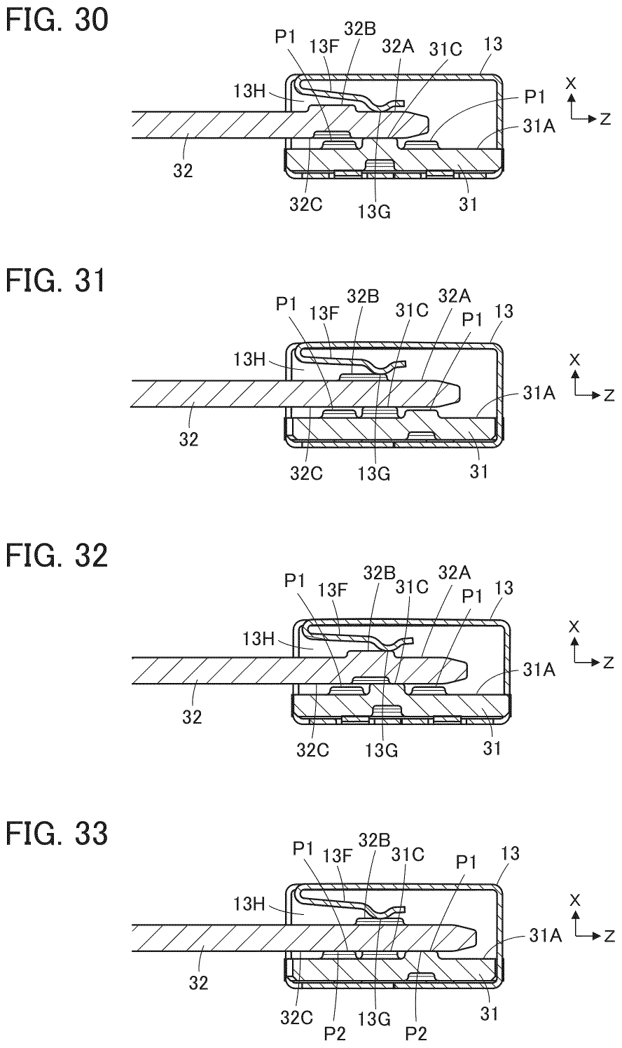

In this process, as shown in FIGS. 29 and 30, the +Z directional tip end of the second terminal 32 is inserted in the +Z direction as passing between the first terminal 31 and the spring member 13F, and the top parts of the two projections 31C of the first terminal 31 are situated on the +X direction side from the first contact portions P1. Hence, the second opposing surface 32C, facing in the −X direction, of the second terminal 32 is situated over the top parts of the two projections 31C without making contact with the first contact portions P1, and the spring member-opposing surface 32A, facing in the +X direction, of the second terminal 32 makes contact with the pressing portion 13G of the spring member 13F to elastically compress the spring member 13F toward the +X direction.

In this state, the second terminal 32 is inserted in the second terminal accommodation portion 13H formed between the spring member 13F and the first opposing surface 31A of the first terminal 31.

In the state as shown in FIGS. 29 and 30, the pressed portions 32B projecting in the +X direction from the spring member-opposing surface 32A of the second terminal 32 are situated on the −Z direction side from the pressing portion 13G of the spring member 13F and are thus not in contact with the pressing portion 13G yet.

When the second terminal 32 is inserted further in the +Z direction, as shown in FIGS. 31 and 32, with the second opposing surface 32C of the second terminal 32 being kept over the top parts of the two projections 31C of the first terminal 31, the pressed portions 32B of the second terminal 32 make contact with the pressing portion 13G of the spring member 13F, and the pressing portion 13G rides on the pressed portions 32B projecting in the +X direction from the spring member-opposing surface 32A of the second terminal 32.

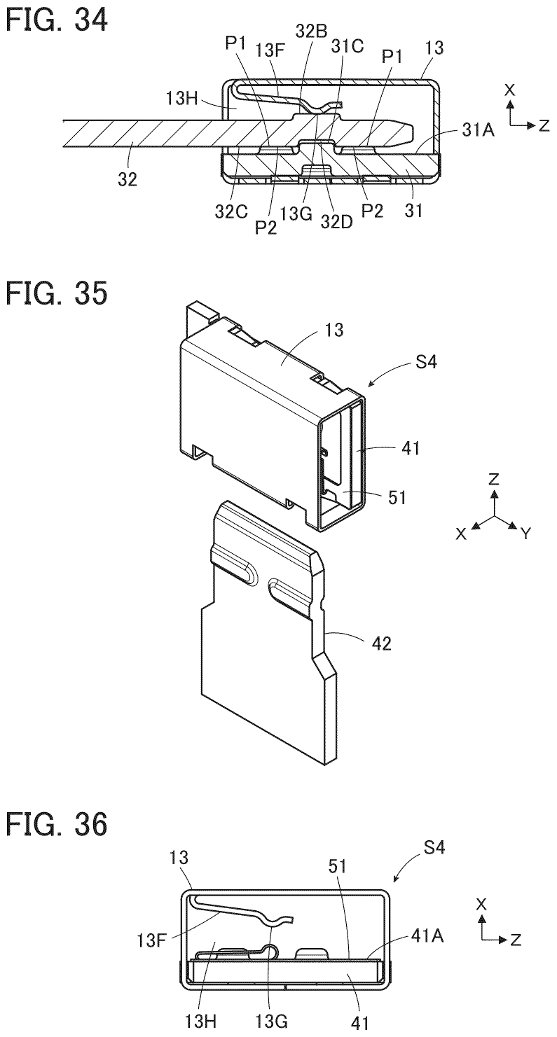

In this state, when insertion of the second terminal 32 in the +Z direction continues, as shown in FIGS. 33 and 34, with the pressing portion 13G of the spring member 13F being kept on the pressed portions 32B of the second terminal 32, the projection accommodation portions 32D formed in the second opposing surface 32C of the second terminal 32 are situated on the +X direction side from the two projections 31C of the first terminal 31 and separately accommodate the two projections 31C. The position of the second terminal 32 in the second terminal accommodation portion 13H at this time is called “connection completion position.”

Since the projection accommodation portions 32D of the second terminal 32 have a depth dimension larger than the height difference in the X direction between the top parts of the projections 31C and the first contact portions P1 of the first terminal 31, when the second terminal 32 is disposed at the connection completion position and the two projections 31C are thus accommodated in the projection accommodation portions 32D, a predetermined gap is formed between the top part of each projection 31C and the bottom part of each projection accommodation portion 32D, and the second opposing surface 32C of the second terminal 32 makes contact with the three first contact portions P1 of the first terminal 31.

At this time, three places in the second opposing surface 32C at which the three first contact portions P1 are in contact therewith each form a second contact portion P2 in the second terminal 32.

Since the pressing portion 13G of the spring member 13F is positioned on the pressed portions 32B of the second terminal 32 as shown in FIGS. 33 and 34, the second terminal 32 is pressed against the first terminal 31 by the spring member 13F via the pressed portions 32B, and the first contact portions P1 and the second contact portions P2 make contact with each other with a predetermined contact pressure, whereby the first terminal 31 and the second terminal 32 are electrically connected to each other.

As described above, during the process of inserting the second terminal 32 to the connection completion position, the second opposing surface 32C of the second terminal 32 is in contact only with the top parts of the two projections 31C of the first terminal 31, and when the second terminal 32 is disposed at the connection completion position and the two projections 31C are accommodated in the projection accommodation portions 32D, the second opposing surface 32C of the second terminal 32 makes contact with the three first contact portions P1 of the first terminal 31 for the first time.

Moreover, since the two projections 31C of the first terminal 31 are so situated as not to overlap the three first contact portions P1 in the Z direction, i.e., insertion direction of the second terminal 32, the three first contact portions P1 of the first terminal 31 make contact with the three second contact portions P2 of the second terminal 32 without being rubbed by any part of the second terminal 32. Similarly, the three second contact portions P2 of the second terminal 32 make contact with the three first contact portions P1 of the first terminal 31 without being rubbed by any part of the first terminal 31.

Hence, as with Embodiments 1 and 2, it is also possible in the connector according to Embodiment 3 to largely suppress wear of the first contact portions P1 and the second contact portions P2 in the process of insertion of the second terminal 32 into the second terminal accommodation portion 13H to thereby electrically connect the first terminal 31 and the second terminal 32 to each other with high reliability.

### Embodiment 4

FIG. 35 shows a connector according to Embodiment 4. The connector includes a first terminal 41 and a second terminal 42. To the first terminal 41, a projection forming component 51 and the spring member retaining portion 13 are attached, and the first terminal 41, the projection forming component 51, and the spring member retaining portion 13 constitute a first terminal structure S4.

The first terminal 41 and the second terminal 42 are each made of a conductive material such as metal and have a flat plate shape.

The second terminal 42 is inserted in the first terminal structure S4 to be thereby electrically connected to the first terminal 41.

The spring member retaining portion 13 is the same as the spring member retaining portion 13 used in the first terminal structure S1 in Embodiment 1.

As shown in FIG. 36, the spring member retaining portion 13 is attached to the first terminal 41 in such a manner that the first terminal 41 is situated inside the spring member retaining portion 13 and in contact with the bottom plate portion 13A of the spring member retaining portion 13.

The +X directional surface of the first terminal 41 constitutes a first opposing surface 41A opposing the second terminal 42, the projection forming component 51 is attached on the first opposing surface 41A in such a manner that part of the first opposing surface 41A is exposed, and between the exposed part of the first opposing surface 41A together with the projection forming component 51 and the spring member 13F, formed is the second terminal accommodation portion 13H in which the second terminal 42 is inserted.

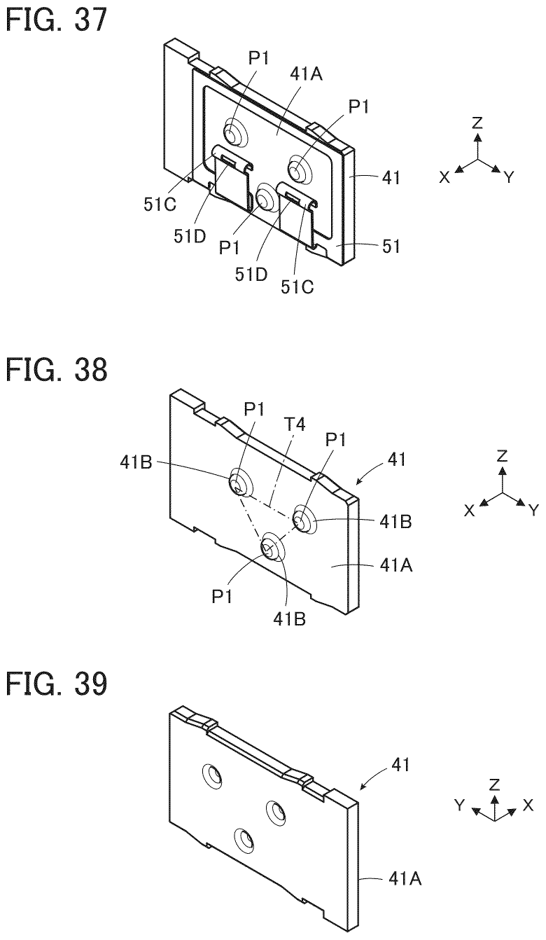

FIG. 37 shows the first terminal 41 to which the projection forming component 51 is attached. The projection forming component 51 has a frame shape, and part of the first opposing surface 41A of the first terminal 41 is exposed through an inner part of the projection forming component 51.

As shown in FIG. 38, the first opposing surface 41A of the first terminal 41 is provided with three first protrusion portions 41B each projecting toward the +X direction. The three first protrusion portions 41B are arranged at three vertexes of an isosceles triangle T4 having a symmetrical shape with respect to the Z direction, and a first contact portion P1 is formed at a top part, facing in the +X direction, of each first protrusion portion 41B.

The three first protrusion portions 41B can be formed by subjecting the first terminal 41 to press working, and the back surface on the −X direction side of the first terminal 41 is thus provided with three recesses corresponding to the first protrusion portions 41B as shown in FIG. 39.

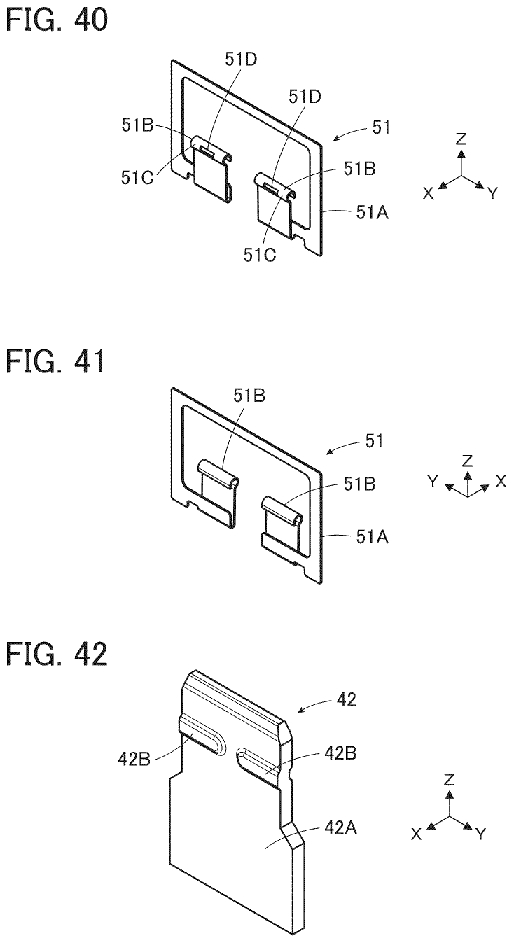

The projection forming component 51 is formed of a metal plate cut out in a frame shape and bent as shown in FIG. 40, and includes a frame shape portion 51A extending along a YZ plane and two tubular portions 51B joined to the frame shape portion 51A. The two tubular portions 51B are each formed by bending the metal plate constituting the projection forming component 51 into a tubular shape about a center axis extending in the Y direction, are aligned in the Y direction, and are disposed with a distance therebetween in the Y direction. The two tubular portions 51B form two projections 51C each projecting in the +X direction.

At a center part in the Y direction of each tubular portion 51B, a cutout 51D is formed by cutting out a +X directional part of the tubular portion 51B.

With the two tubular portions 51B being disposed with a distance therebetween in the Y direction, and each tubular portion 51B being provided with the cutout 51D, it is configured such that, as shown in FIG. 37, the projections 51C are so situated as not to overlap the three first contact portions P1 of the first terminal 41 in the Z direction, i.e., insertion direction of the second terminal 42 when the projection forming component 51 is attached to the first opposing surface 41A of the first terminal 41.

The projection height, from the first opposing surface 41A, of the projections 51C formed of the projection forming component 51 is higher than the height of the three first contact portions P1 from the first opposing surface 31A, and a top part in the +X direction of each projection 51C is situated on the +X direction side from the first contact portion P1.

The projection forming component 51 as above can be attached to the first opposing surface 41A of the first terminal 41 by, for example, welding.

As shown in FIG. 42, the front surface on the +X direction side of the second terminal 42 constitutes a spring member-opposing surface 42A opposing the spring member 13F when the second terminal 42 is inserted in the second terminal accommodation portion 13H of the first terminal structure S4, and the spring member-opposing surface 42A is provided with two pressed portions 42B projecting toward the +X direction. The two pressed portions 42B are aligned in the Y direction and disposed with a distance therebetween in the Y direction.

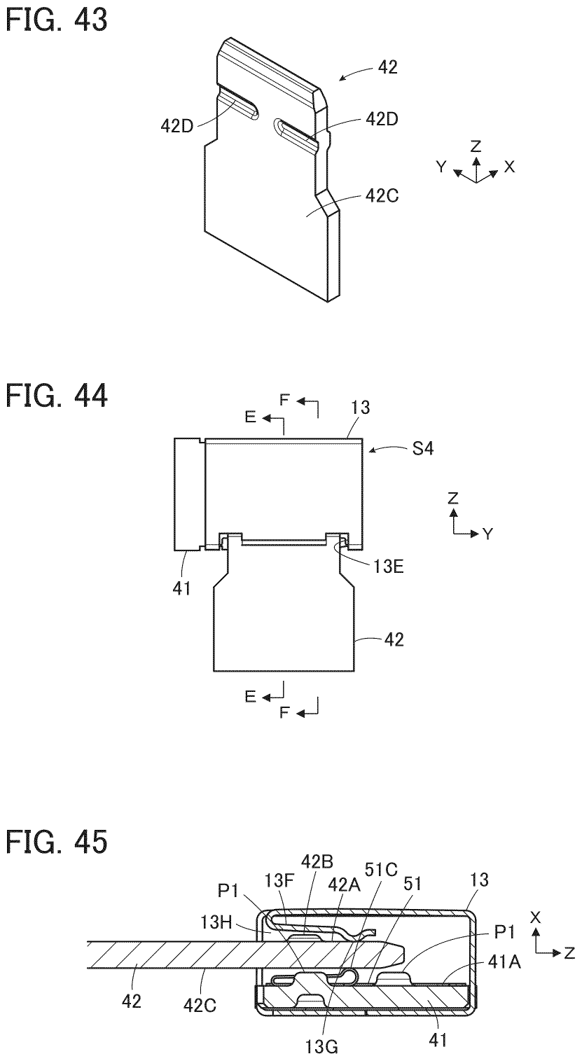

In addition, as shown in FIG. 43, the back surface on the −X direction side of the second terminal 42 constitutes a second opposing surface 42C opposing the first opposing surface 41A of the first terminal 41 when the second terminal 42 is inserted in the second terminal accommodation portion 13H of the first terminal structure S4, and the second opposing surface 42C is provided with two projection accommodation portions 42D of recess shape recessed toward the +X direction.

The two projection accommodation portions 42D are aligned in the Y direction and disposed with a distance therebetween in the Y direction. The two projection accommodation portions 42D each have a size and have a Y directional distance therebetween with which the two projections 51C of the projection forming component 51 attached to the first terminal 41 can be separately accommodated therein.

Moreover, the two projection accommodation portions 42D each have a depth dimension larger than the height difference in the X direction between the +X directional top part of each projection 51C of the projection forming component 51 and the first contact portion P1 of the first terminal 41.

In addition, the two pressed portions 42B of the second terminal 42 and the two projection accommodation portions 42D can be simultaneously formed by a single step of subjecting the second terminal 42 to press working, and are arranged at the same positions in a YZ plane.

Next, the operation of the connector according to Embodiment 4 is described.

To electrically connect the second terminal 42 to the first terminal 41, the second terminal 42 shown in FIG. 35 is moved in the +Z direction from the −Z direction, and the tip end of the second terminal 42 is inserted into the spring member retaining portion 13 through the opening 13E of the spring member retaining portion 13 of the first terminal structure S4 as shown in FIG. 44.

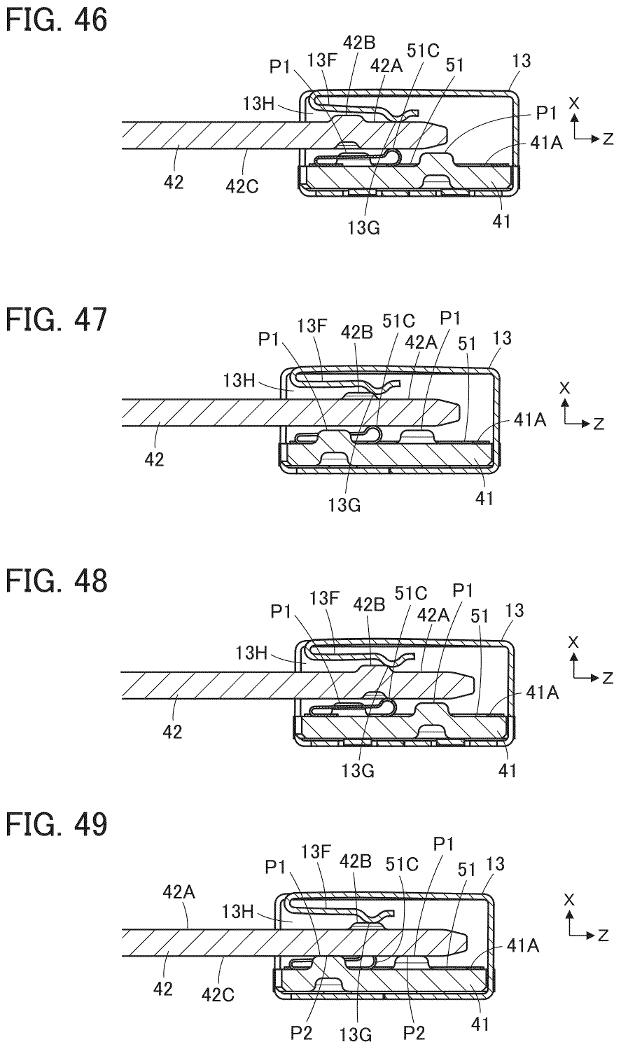

In this process, as shown in FIGS. 45 and 46, the +Z directional tip end of the second terminal 42 is inserted in the +Z direction as passing between the projection forming component 51 and the spring member 13F, and the +X directional top parts of the two projections 51C of the projection forming component 51 are situated on the +X direction side from the first contact portions P1. Hence, the second opposing surface 42C, facing in the −X direction, of the second terminal 42 is situated over the top parts of the two projections 51C without making contact with the first contact portions P1, and the spring member-opposing surface 42A, facing in the +X direction, of the second terminal 42 makes contact with the pressing portion 13G of the spring member 13F to elastically compress the spring member 13F toward the +X direction.

In this state, the second terminal 42 is inserted in the second terminal accommodation portion 13H formed between the spring member 13F and the first opposing surface 41A of the first terminal 41 together with the projection forming component 51.

In the state as shown in FIGS. 45 and 46, the pressed portions 42B projecting in the +X direction from the spring member-opposing surface 42A of the second terminal 42 are situated on the −Z direction side from the pressing portion 13G of the spring member 13F and are thus not in contact with the pressing portion 13G yet.

When the second terminal 42 is inserted further in the +Z direction, as shown in FIGS. 47 and 48, with the second opposing surface 42C of the second terminal 42 being kept over the top parts of the two projections 51C of the projection forming component 51, the pressed portions 42B of the second terminal 42 make contact with the pressing portion 13G of the spring member 13F, and the pressing portion 13G rides on the pressed portions 42B projecting in the +X direction from the spring member-opposing surface 42A of the second terminal 42.

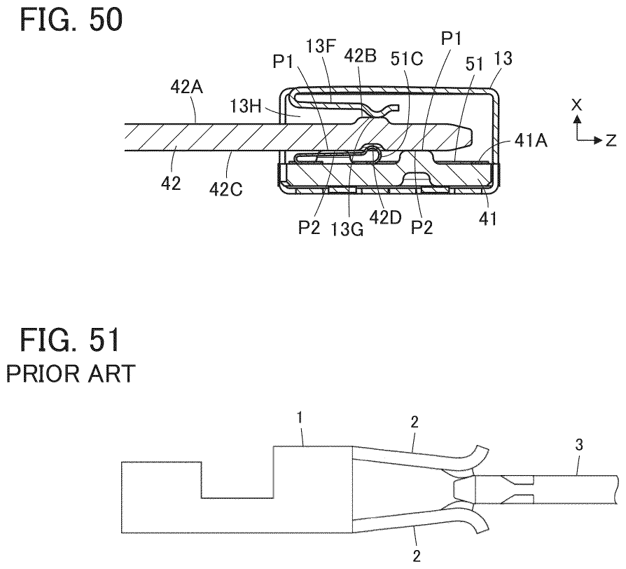

In this state, when insertion of the second terminal 42 in the +Z direction continues, as shown in FIGS. 49 and 50, with the pressing portion 13G of the spring member 13F being kept on the pressed portions 42B of the second terminal 42, the projection accommodation portions 42D formed in the second opposing surface 42C of the second terminal 42 are situated on the +X direction side from the two projections 51C of the projection forming component 51 and separately accommodate the two projections 51C. The position of the second terminal 42 in the second terminal accommodation portion 13H at this time is called “connection completion position.”

Since the projection accommodation portions 42D of the second terminal 42 have a depth dimension larger than the height difference in the X direction between the +X directional top parts of the projections 51C of the projection forming component 51 and the first contact portions P1 of the first terminal 41, when the second terminal 42 is disposed at the connection completion position and the two projections 51C are thus accommodated in the projection accommodation portions 42D, a predetermined gap is formed between the top part of each projection 51C and the bottom part of each projection accommodation portion 42D, and the second opposing surface 42C of the second terminal 42 makes contact with the three first contact portions P1 of the first terminal 41.

At this time, three places in the second opposing surface 42C at which the three first contact portions P1 are in contact therewith each form a second contact portion P2 in the second terminal 42.

Since the pressing portion 13G of the spring member 13F is positioned on the pressed portions 42B of the second terminal 42 as shown in FIGS. 49 and 50, the second terminal 42 is pressed against the first terminal 41 by the spring member 13F via the pressed portions 42B, and the first contact portions P1 and the second contact portions P2 make contact with each other with a predetermined contact pressure, whereby the first terminal 41 and the second terminal 42 are electrically connected to each other.

As described above, during the process of inserting the second terminal 42 to the connection completion position, the second opposing surface 42C of the second terminal 42 is in contact only with the top parts of the two projections 51C of the projection forming component 51, and when the second terminal 42 is disposed at the connection completion position and the two projections 51C are separately accommodated in the projection accommodation portions 42D, the second opposing surface 42C of the second terminal 42 makes contact with the three first contact portions P1 of the first terminal 41 for the first time.

Moreover, since the two projections 51C of the projection forming component 51 are so situated as not to overlap the three first contact portions P1 in the Z direction, i.e., insertion direction of the second terminal 42, the three first contact portions P1 of the first terminal 41 make contact with the three second contact portions P2 of the second terminal 42 without being rubbed by any part of the second terminal 42. Similarly, the three second contact portions P2 of the second terminal 42 make contact with the three first contact portions P1 of the first terminal 41 without being rubbed by any part of the first terminal 41 and the projection forming component 51.

Hence, as with Embodiments 1 to 3, it is also possible in the connector according to Embodiment 4 to largely suppress wear of the first contact portions P1 and the second contact portions P2 in the process of insertion of the second terminal 42 into the second terminal accommodation portion 13H to thereby electrically connect the first terminal 41 and the second terminal 42 to each other with high reliability.

In Embodiments 1, 3, and 4 described above, the three first contact portions P1 of the first terminal 11, 31, 41 are each formed of, for example, the top part of the first protrusion portion 11B, 31B, 41B of the first terminal 11, 31, 41, but the invention is not limited thereto. For instance, three metal balls are rotatably retained by the first terminal 11, 31, 41 in such a manner that part of each metal ball projects from the first opposing surface 11A, 31A, 41A, and the metal ball surface projecting from the first opposing surface 11A, 31A, 41A is used as the first contact portion P1, whereby the first terminal 11, 31, 41 can be electrically connected to the second terminal 12, 32, 42.

With the surface of such rotatable metal ball constituting the first contact portion P1, when the first contact portion P1 makes contact with the second terminal 12, 32, 42 in the insertion process of the second terminal 12, 32, 42, the metal ball rotates, and hence wear of the first contact portion P1 is further suppressed, whereby reliability of the electrical connection between the first terminal 11, 31, 41 and the second terminal 12, 32, 42 can be improved.

In Embodiments 1 to 4 described above, three first contact portions P1 make contact with three second contact portions P2, but the invention is not limited thereto, and it suffices if one or more first contact portions P1 make contact with one or more second contact portions P2. Meanwhile, the connector is preferably configured such that the three first contact portions P1 make contact with the three second contact portions P2 as in Embodiments 1 to 4, because the first terminal 11, 21, 31, 41 and the second terminal 12, 22, 32, 42 when connected to each other are positionally stabilized, thereby improving reliability of the electrical connection.

In Embodiments 1 to 4 described above, three first contact portions P1 and three second contact portions P2 are arranged at three vertexes of the isosceles triangle T1 to T4, but the contact portions are not limited to be arranged at vertexes of an isosceles triangle. Meanwhile, the three first contact portions P1 and the three second contact portions P2 are preferably arranged at three vertexes of the isosceles triangle T1 to T4 for positionally stabilizing the first terminal 11, 21, 31, 41 and the second terminal 12, 22, 32, 42 when connected to each other.

In addition, in Embodiments 1 to 4 described above, the two projections 11C, 21C, 31C, 51C are used, but the invention is not limited thereto. Meanwhile, the two projections 11C, 21C, 31C, 51C aligned in the Y direction are preferably used as in Embodiments 1 to 4 for positionally stabilizing the second terminal 12, 22, 32, 42 in the process of insertion.

What is claimed is:

1. A connector in which a second terminal of flat plate shape is moved in parallel with and superposed on a first terminal of flat plate shape to thereby connect the first terminal and the second terminal to each other, the connector comprising:
a spring member attached to the first terminal and configured to press the second terminal toward the first terminal;
wherein the first terminal includes a first opposing surface and a first contact portion facing the second terminal,
a second terminal accommodation portion in which the second terminal is inserted is formed between the first opposing surface and the spring member,
the second terminal includes a second opposing surface opposing the first opposing surface, a second contact portion facing the first terminal, and a pressed portion formed on and projecting from a spring member-opposing surface opposing the spring member,
one of the first opposing surface and the second opposing surface is provided with a projection projecting toward another of the first opposing surface and the second opposing surface, and the another is provided with a projection accommodation portion of recess shape for accommodating the projection, and
when the second terminal is inserted along a predetermined insertion direction to a predetermined connection completion position in the second terminal accommodation portion, the projection is accommodated in the projection accommodation portion so that the second terminal is retained at the predetermined connection completion position, the second terminal is pressed against the first terminal by the spring member via the pressed portion, and the first contact portion and the second contact portion make contact with each other, whereby the first terminal and the second terminal are electrically connected to each other.

2. The connector according to claim 1, wherein when the second terminal is inserted to the predetermined connection completion position, a predetermined gap is formed between a top part of the projection and a bottom part of the projection accommodation portion.

3. The connector according to claim 1,
wherein the first terminal includes a first protrusion portion formed on and projecting from the first opposing surface,
the first contact portion is disposed at a top part of the first protrusion portion, and
the second contact portion is disposed on the second opposing surface.

4. The connector according to claim 1,
wherein the second terminal includes a second protrusion portion formed on and projecting from the second opposing surface,
the second contact portion is disposed at a top part of the second protrusion portion, and
the first contact portion is disposed on the first opposing surface.

5. The connector according to claim 1, wherein the first contact portion and the second contact portion are so situated as not to overlap the projection in the predetermined insertion direction.

6. The connector according to claim 5,
wherein the first terminal includes a plurality of the first contact portions, and
the second terminal includes a plurality of the second contact portions corresponding to the plurality of the first contact portions.

7. The connector according to claim 6, wherein the plurality of the first contact portions and the plurality of the second contact portions respectively consist of the three first contact portions and the three second contact portions separately arranged at vertexes of an isosceles triangle having a symmetrical shape with respect to the predetermined insertion direction.

8. The connector according to claim 7, wherein the projection and the projection accommodation portion are arranged on a side of the isosceles triangle or inside the isosceles triangle.

9. The connector according to claim 7, wherein the projection and the projection accommodation portion are arranged outside the isosceles triangle.

10. The connector according to claim 1, wherein the projection is formed integrally with one of the first opposing surface and the second opposing surface.

11. The connector according to claim 1, comprising a projection forming component attached on the first opposing surface in such a manner that the first contact portion is exposed,
wherein the projection is formed in the projection forming component.

12. The connector according to claim 1, wherein the projection is formed in the first opposing surface, the projection accommodation portion is formed in the second opposing surface, and the pressed portion is formed at a same position as the projection accommodation portion in the spring member-opposing surface.

13. The connector according to claim 1, comprising a spring member retaining portion attached to the first terminal and retaining the spring member such that the spring member opposes the first opposing surface.
